(19) United States
(12) Patent Application Publication
(10) Pub. No.: US 2025/0379381 A1
(43) Pub. Date: Dec. 11, 2025

(54) INTERFACE CONNECTOR AND METHOD FOR MANUFACTURING THE SAME

(71) Applicant: Japan Aviation Electronics Industry, Ltd., Tokyo (JP)

(72) Inventors: Junji Oosaka, Tokyo (JP); Akihiro Matsunaga, Tokyo (JP)

(73) Assignee: Japan Aviation Electronics Industry, Ltd., Tokyo (JP)

(21) Appl. No.: 19/196,204

(22) Filed: May 1, 2025

(30) Foreign Application Priority Data
Jun. 6, 2024 (JP) 2024-091883

(51) Int. Cl. H01R 12/72; H01R 12/70; H01R 13/05; H01R 13/502; H01R 13/64; H01R 13/652

(52) U.S. Cl. CPC H01R 12/722; H01R 12/7047; H01R 13/05; H01R 13/502; H01R 13/64; H01R 13/652

(57) ABSTRACT

An interface connector where a ground path can be easily formed is provided. An interface connector according to the present disclosure includes a housing and a contact assembly. The housing is a shell block including a plurality of parts having different thicknesses and has a cutout which accommodates the contact assembly. The contact assembly includes contacts, a metal plate, and an insulating member that holds the contacts and the metal plate. A protruding part of the metal plate protruded from the insulating member is welded to a first flat part of the cutout of the housing in a state in which the protruding part of the metal plate is placed on the first flat part of the cutout of the housing.

### INCORPORATION BY REFERENCE

This application is based upon and claims the benefit of priority from Japanese patent application No. 2024-91883, filed on Jun. 6, 2024, the disclosure of which is incorporated herein in its entirety by reference.

### BACKGROUND

The present disclosure relates to an interface connector and a method for manufacturing the same.

In general, an interface connector is used to electrically connect a connection substrate to a connection connector. For example, as shown in FIG. 21, an interface connector 101 disclosed in Patent Literature 1 includes contacts 102 arranged in a width direction of the interface connector 101, a metal plate 103, an insulating member 104 that holds the contacts 102 and the metal plate 103, and a housing 105 that accommodates the insulating member 104.

The aforementioned interface connector 101 is configured to electrically connect the metal plate 103 to the housing 105 by welding together an abutting part of a part 103a of the metal plate 103 that is protruded from the insulating member 104 to a protruding part 105a of the housing 105 in a direction in which the connection connector is inserted and removed in order to form a ground path.

[Patent Literature 1] Japanese Unexamined Patent Application Publication No. 2016-143444

### SUMMARY

In the interface connector 101 according to Patent Literature 1, the abutting area of the part 103a of the metal plate 103 that is protruded from the insulating member 104 to the protruding part 105a of the housing 105 in the direction in which the connection connector is inserted and removed is small.

Therefore, it is difficult to cause the part 103a of the metal plate 103 that is protruded from the insulating member 104 to abut to the protruding part 105a of the housing 105 in the direction in which the connection connector is inserted and removed, and it is thus difficult to cause the above parts to be welded together. Therefore, there is a problem in the interface connector 101 in Patent Literature 1 that it is difficult to form a ground path.

An object of the present disclosure is to provide an interface connector where a ground path can be easily formed and a method for manufacturing the interface connector.

An interface connector according to one aspect of the present disclosure is an interface connector for electrically connecting a connection connector to a connection substrate, the interface connector including: a housing; and a contact assembly held by the housing, in which the housing is a shell block including a plurality of parts having different thicknesses and has a cutout which accommodates the contact assembly, the contact assembly includes: contacts including first electric contacts electrically connected to the connection connector and second electric contacts electrically connected to the connection substrate; a metal plate; and an insulating member that holds the contacts and the metal plate and into which the connection connector is fit, and a protruding part of the metal plate protruded from the insulating member in a width direction of the housing is welded to a first flat part of a cutout of the housing, the first flat part being formed in an end part of the cutout of the housing in the width direction of the housing, in a state in which the protruding part of the metal plate is placed on the first flat part of the cutout of the housing.

A method for manufacturing an interface connector according to one aspect of the present disclosure is a method for manufacturing an interface connector for electrically connecting a connection connector to a connection substrate, the interface connector including: a housing; and a contact assembly held by the housing, the method including: forming a shell block including a plurality of parts having different thicknesses as the housing; insert-molding contacts including first electric contacts electrically connected to the connection connector and second electric contacts electrically connected to the connection substrate and a metal plate into an insulating member to form a contact assembly; accommodating the contact assembly in a cutout formed in the housing; and welding a protruding part of the metal plate protruded from the insulating member in a width direction of the housing to a flat part of a cutout of the housing, the flat part being formed in an end part of the cutout of the housing in the width direction of the housing, in a state in which the protruding part is placed on the flat part of the cutout of the housing.

According to the present disclosure, it is possible to provide an interface connector where a ground path can be easily formed and a method for manufacturing the interface connector.

The above and other objects, features and advantages of the present disclosure will become more fully understood from the detailed description given hereinbelow and the accompanying drawings.

### BRIEF DESCRIPTION OF DRAWINGS

FIG. 1 is a perspective view showing a state in which an interface connector according to an embodiment electrically connects a connection connector to a connection substrate as seen from a positive side of a Z-axis;

FIG. 2 is a perspective view showing a state in which the interface connector according to the embodiment is fixed to the connection substrate as seen from the positive side of the Z-axis;

FIG. 3 is a perspective view of the interface connector according to the embodiment as seen from a negative side of the Z-axis;

FIG. 4 is another perspective view of the interface connector according to the embodiment as seen from the negative side of the Z-axis;

FIG. 5 is a diagram showing the interface connector according to the embodiment as seen from the negative side of the Z-axis;

FIG. 6 is an exploded view showing the interface connector according to the embodiment;

FIG. 7 is a perspective view of a housing of the interface connector according to the embodiment as seen from the positive side of the Z-axis;

FIG. 8 is a perspective view of the housing of the interface connector according to the embodiment as seen from the negative side of the Z-axis;

FIG. 9 is a YZ cross-sectional view showing a state in which a ground plate of the interface connector according to the embodiment is fixed to the housing;

FIG. 10 is a perspective view showing a state in which a first contact group, a second contact group, a midplate, and an insulating member of the interface connector according to the embodiment are integrated as seen from the negative side of the Z-axis;

FIG. 11 is a perspective view showing a state in which the first contact group, the second contact group, the midplate, and the insulating member of the interface connector according to the embodiment are integrated as seen from the positive side of the Z-axis;

FIG. 12 is a YZ cross-sectional view showing the interface connector according to the embodiment;

FIG. 13 is a YZ cross-sectional view showing the first contact group, the second contact group, and the midplate of the interface connector according to the embodiment;

FIG. 14 is a diagram showing the contact from a negative side of an X-axis in order to describe the name of each part of the contact of the interface connector according to the embodiment;

FIG. 15 is a diagram showing a representative contact of the interface connector according to the embodiment as seen from a positive side of a Y-axis;

FIG. 16 is a perspective view of the midplate of the interface connector according to the embodiment as seen from the negative side of the Z-axis;

FIG. 17 is a perspective view of a locator of the interface connector according to the embodiment as seen from the negative side of the Z-axis;

FIG. 18 is a perspective view of the locator of the interface connector according to the embodiment as seen from the positive side of the Z-axis;

FIG. 19 is an enlarged view of a part XIX of FIG. 4;

FIG. 20 is a YZ cross-sectional view showing a state in which the interface connector according to the embodiment is fixed to the connection substrate; and

FIG. 21 is a diagram showing FIG. 11 of Patent Literature 1.

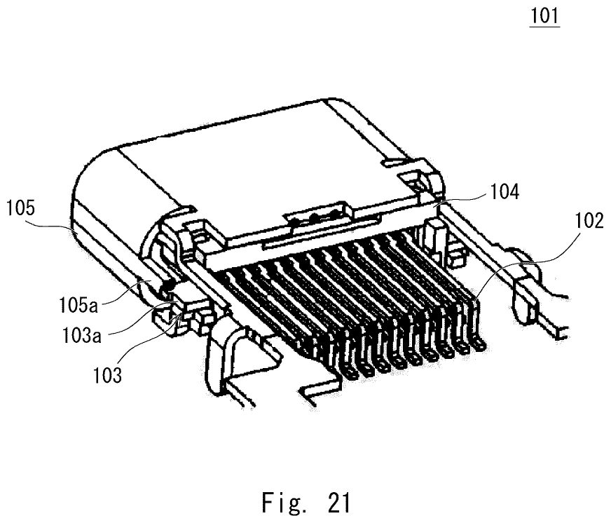

### DESCRIPTION OF EMBODIMENTS

Hereinafter, with reference to the drawings, specific embodiments to which the present disclosure is applied will be described in detail. Note that the present disclosure is not limited to the following embodiments. Further, for the sake of clarity of the description, the following descriptions and the drawings are simplified as appropriate. In the following description, a three-dimensional (XYZ) coordinate system is used to clarify the explanation.

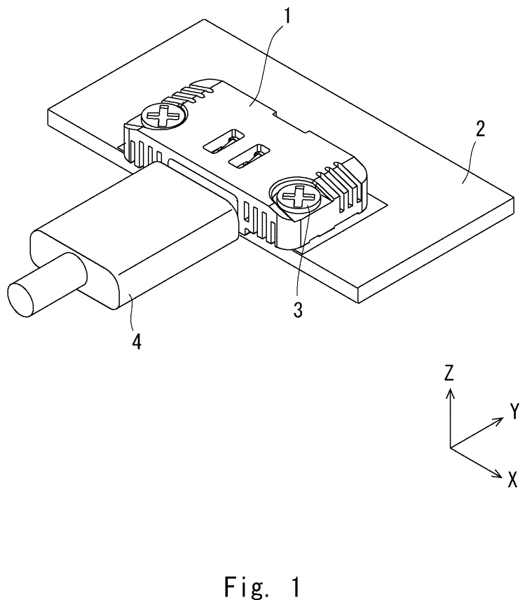

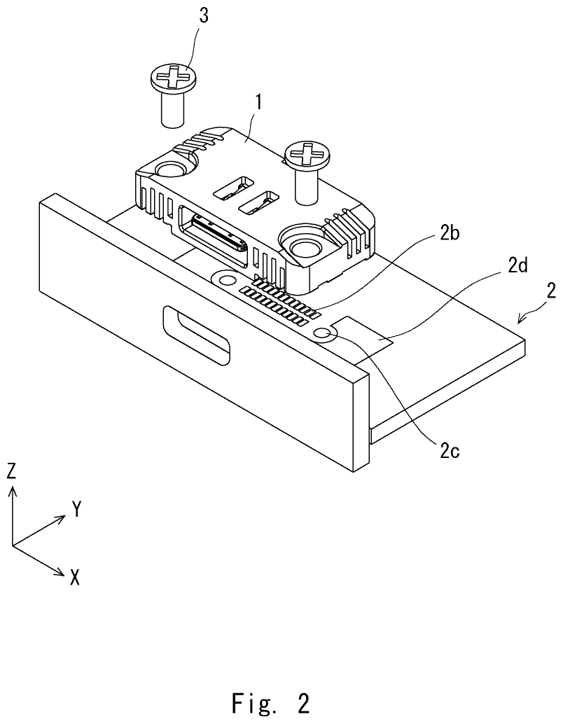

FIG. 1 is a perspective view showing a state in which an interface connector according to this embodiment electrically connects a connection connector to a connection substrate as seen from a positive side of a Z-axis. FIG. 2 is a perspective view showing a state in which the interface connector according to this embodiment is fixed to the connection substrate as seen from the positive side of the Z-axis.

As shown in FIGS. 1 and 2, in an interface connector 1, a connection connector 4 is fit into the interface connector 1 in a state in which the interface connector 1 is fixed to a connection substrate 2 by screws 3, whereby the interface connector 1 electrically connects the connection substrate 2 to the connection connector 4. In this state, an X-axis direction corresponds to a width direction of the interface connector 1, a Y-axis direction corresponds to a direction in which the connection connector 4 is inserted and removed, and the Z-axis direction corresponds to a thickness direction of the interface connector 1.

The connection substrate 2 may be a main board on which a Central Processing Unit (CPU) and so on are mounted. Further, the connection connector 4 may be, for example, a USB Type-C (registered trademark).

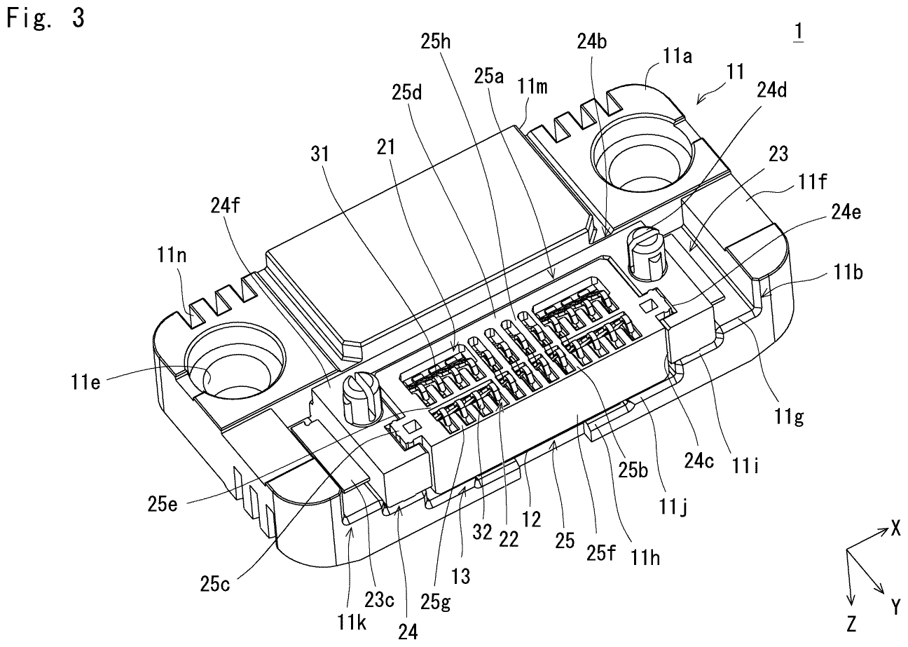

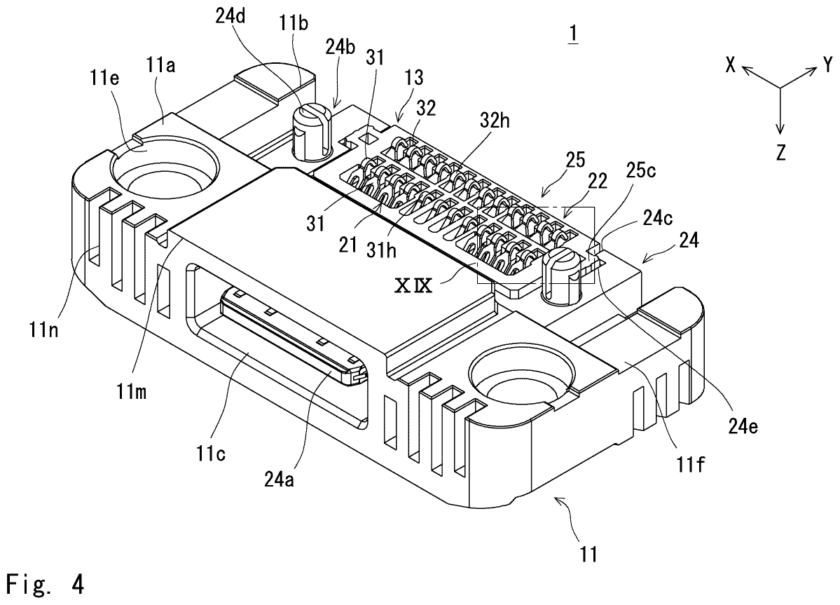

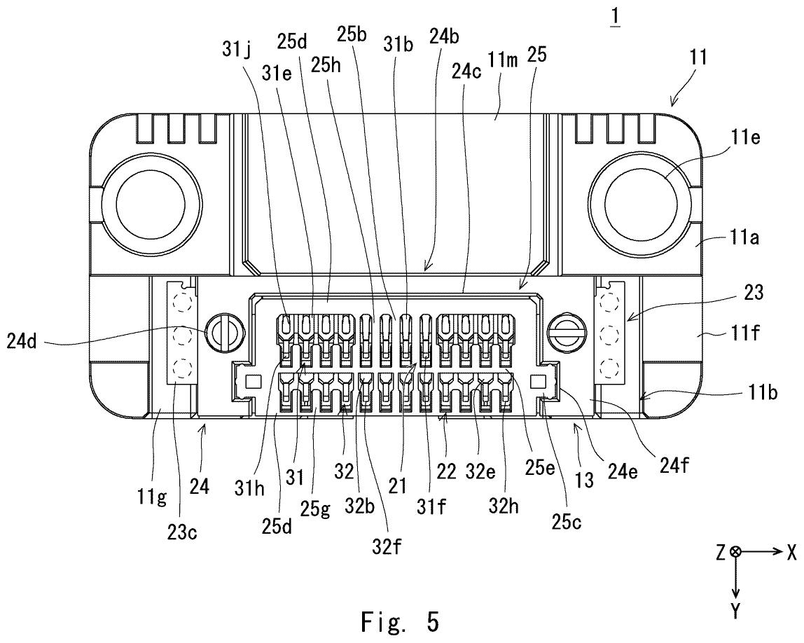

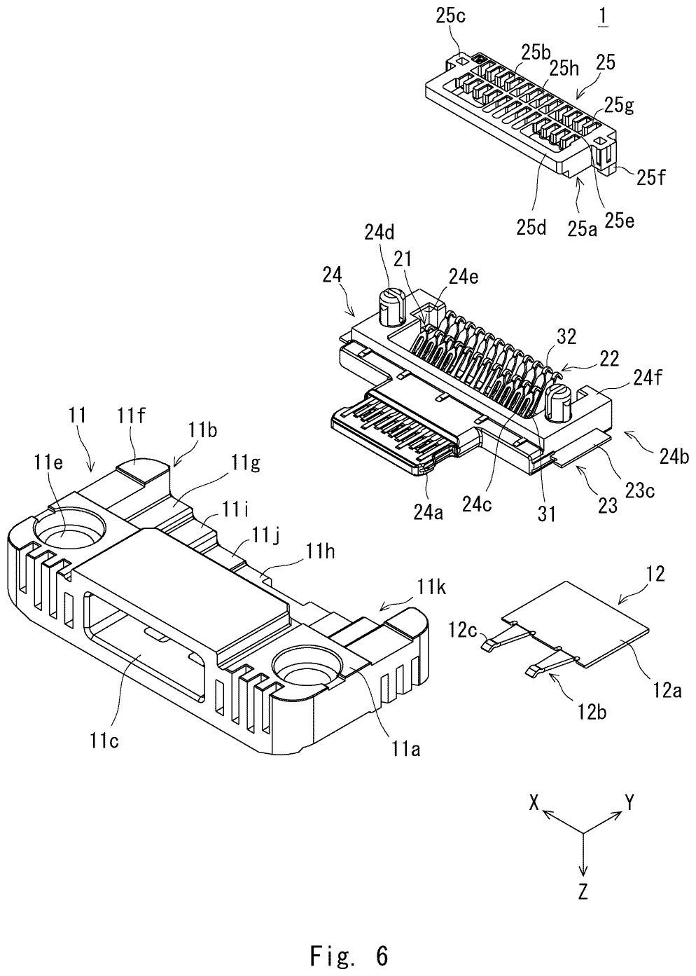

FIG. 3 is a perspective view of the interface connector according to this embodiment as seen from a negative side of the Z-axis. FIG. 4 is another perspective view of the interface connector according to this embodiment as seen from the negative side of the Z-axis. FIG. 5 is a diagram showing the interface connector according to this embodiment as seen from the negative side of the Z-axis. FIG. 6 is an exploded view showing the interface connector according to this embodiment.

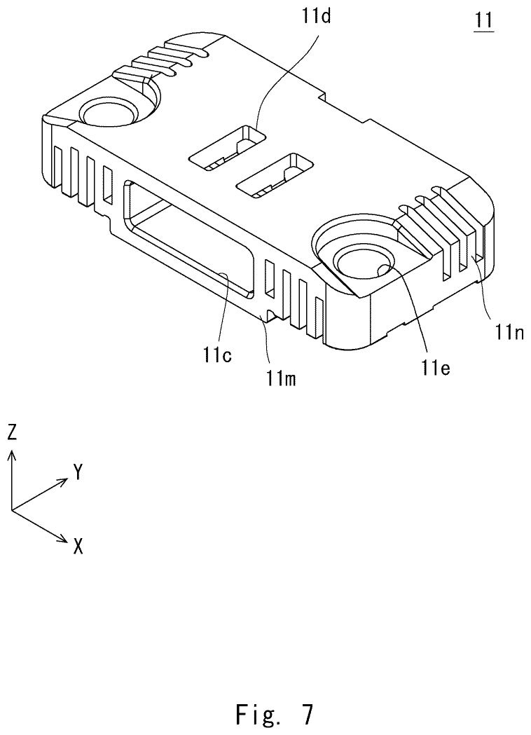

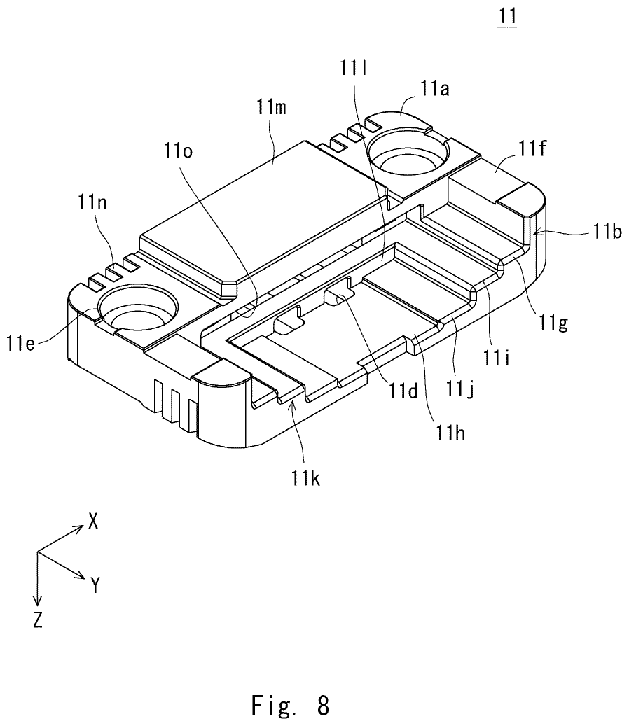

As shown in FIGS. 3 to 6, for example, the interface connector 1 includes a housing 11, a ground plate 12, and a contact assembly 13. FIG. 7 is a perspective view of the housing of the interface connector according to this embodiment as seen from the positive side of the Z-axis. FIG. 8 is a perspective view of the housing of the interface connector according to this embodiment as seen from the negative side of the Z-axis.

As shown in FIGS. 6 to 8, the housing 11, which has a substantially rectangular shape as seen from the Z-axis direction, is a flat block body in the Z-axis direction. The housing 11 may be a conductive molded or machined product made of metal.

More specifically, as shown in FIGS. 6 to 8, the housing 11 includes a flat face 11a, a cutout 11b, a first penetrating hole 11c, second penetrating holes 11d, and third penetrating holes 11e. The flat face 11a is disposed on a surface on the negative side of the Z-axis of the housing 11.

As shown in FIGS. 6 to 8, the cutout 11b cuts out corner parts on the negative side of the Z-axis of the housing 11 on a positive side of the Y-axis of the housing 11, and is disposed between a side wall 11f on a positive side of the X-axis of the housing 11 and a side wall 11f on a negative side of the X-axis of the housing 11. The cutout 11b may have, for example, a substantially rectangular shape that is long in the X-axis direction as seen from the Z-axis direction.

As shown in FIG. 8, for example, the cutout 11b includes a first flat part 11g, a second flat part 11h, a third flat part 11i, and a fourth flat part 11j. The first flat part 11g is disposed, for example, at a position which is one step lower than the flat face 11a of the housing 11 on the positive side of the Z-axis.

As shown in FIG. 8, for example, the first flat part 11g is disposed on each side of the cutout 11b in the X-axis direction. The first flat part 11g, which is disposed, for example, in substantially parallel to the XY-plane, may have a substantially rectangular shape that is long in the Y-axis direction as seen from the Z-axis direction.

As shown in FIG. 8, for example, the second flat part 11h is disposed between the first flat part 11g on the positive side of the X-axis and the first flat part 11g on the negative side of the X-axis in the X-axis direction. The second flat part 11h, which is disposed, for example, in substantially parallel to the XY-plane, may have a substantially rectangular shape that is long in the X-axis direction as seen from the Z-axis direction.

As shown in FIG. 8, for example, the third flat part 11i is disposed between the first flat part 11g and the second flat part 11h. More specifically, the third flat part 11i is disposed at a position which is one step lower than the first flat part 11g on the positive side of the Z-axis. The third flat part 11i is disposed, for example, so as to be adjacent, on the negative side of the X-axis, to the first flat part 11g provided on the positive side of the X-axis.

Further, as shown in FIG. 8, for example, the third flat part 11i is disposed so as to be adjacent, on the positive side of the X-axis, to the first flat part 11g provided on the negative side of the X-axis. The third flat part 11i, which is disposed, for example, in substantially parallel to the XY-plane, may have a substantially rectangular shape that is long in the Y-axis direction as seen from the Z-axis direction.

As shown in FIG. 8, for example, the fourth flat part 11j is disposed between the first flat part 11g and the second flat part 11h. More specifically, the fourth flat part 11j is disposed at a position which is one step lower than the third flat part 11i on the positive side of the Z-axis. The fourth flat part 11j is disposed, for example, so as to be adjacent, on the negative side of the X-axis, to the third flat part 11i provided on the positive side of the X-axis and to be adjacent, on the positive side of the X-axis, to the second flat part 11h.

Further, as shown in FIG. 8, for example, the fourth flat part 11j is disposed so as to be adjacent, on the positive side of the X-axis, to the third flat part 11i provided on the negative side of the X-axis and to be adjacent, on the negative side of the X-axis, to the second flat part 11h. The fourth flat part 11j, which is disposed, for example, in substantially parallel to the XY-plane, may have a substantially rectangular shape that is long in the Y-axis direction as seen from the Z-axis direction.

Therefore, as shown in FIG. 8, for example, a step part 11k formed of the first flat part 11g, the second flat part 11h, the third flat part 11i, and the fourth flat part 11j is formed on each of the part on the positive side of the X-axis and the part on the negative side of the X-axis of the cutout 11b.

The connection connector 4 is inserted into the first penetrating hole 11c. As shown in FIGS. 6 to 8, the first penetrating hole 11c penetrates through the housing 11 in the Y-axis direction. That is, the end part on the positive side of the Y-axis of the first penetrating hole 11c reaches the cutout 11b, and the end part on a negative side of the Y-axis of the first penetrating hole 11c reaches a side surface on the negative side of the Y-axis of the housing 11.

As shown in FIGS. 6 to 8, the first penetrating hole 11c is disposed at substantially the center of the housing 11 in the X-axis direction as seen from the Z-axis direction. The first penetrating hole 11c may have, for example, a substantially rectangular shape that is long in the X-axis direction as seen from the Y-axis direction.

As shown in FIGS. 7 and 8, for example, the second penetrating holes 11d penetrate through the housing 11 in the Z-axis direction in such a way that each of the second penetrating holes 11d reaches the first penetrating hole 11c from the surface on the positive side of the Z-axis of the housing 11. Then, the end part on the positive side of the Y-axis of each of the second penetrating holes 11d reaches a part on the positive side of the Z-axis of a side surface 111 on the negative side of the Y-axis of the cutout 11b.

As shown in FIG. 7, for example, the second penetrating holes 11d may be disposed at substantially the center of the housing 11 in the X-axis direction in such a way that they are spaced apart from each other in the X-axis direction. The second penetrating holes 11d may each have, for example, a substantially rectangular shape that is long in the Y-axis direction as seen from the Z-axis direction.

As shown in FIG. 2, the screws 3 for fixing the interface connector 1 to the connection substrate 2 are made to pass through the third penetrating holes 11e. As shown in FIGS. 6 to 8, the third penetrating holes 11e are disposed in a part on the negative side of the Y-axis of the housing 11 as seen from the Z-axis direction in such a way that they are spaced apart from each other in the X-axis direction so as to sandwich the first penetrating hole 11c therebetween, and penetrate through the housing 11 in the Z-axis direction. The third penetrating holes 11e may each have, for example, a substantially circular shape as seen from the Z-axis direction.

As described above, the housing 11 is formed as a shell block including a plurality of parts having different thicknesses in the Z-axis direction. As shown in FIGS. 7 and 8, for example, the housing 11 may roughly have a plane-symmetrical shape with a YZ-plane passing through the center of the housing 11 in the X-axis direction as a plane of symmetry.

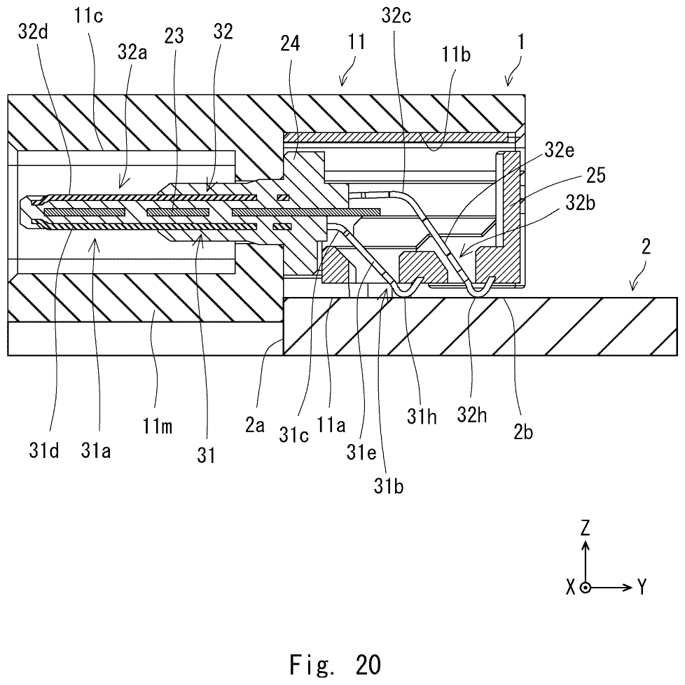

In the above state, as shown in FIGS. 7 and 8, for example, the housing 11 may include a convex part 11m engaged with a cutout 2a (shown in FIG. 20) of the connection substrate 2, radiation fins 11n for radiating heat, and so on.

As shown in FIG. 8, the convex part 11m, which is protruded from a part of the negative side of the Y-axis of the housing 11 toward the negative side of the Z-axis thereof, is extended in the Y-axis direction. The convex part 11m may have, for example, a substantially trapezoidal shape as seen from the Y-axis direction. The radiation fins 11n may each be disposed in a desired place of a part where the housing 11 is exposed when the interface connector 1 is fixed to the connection substrate 2.

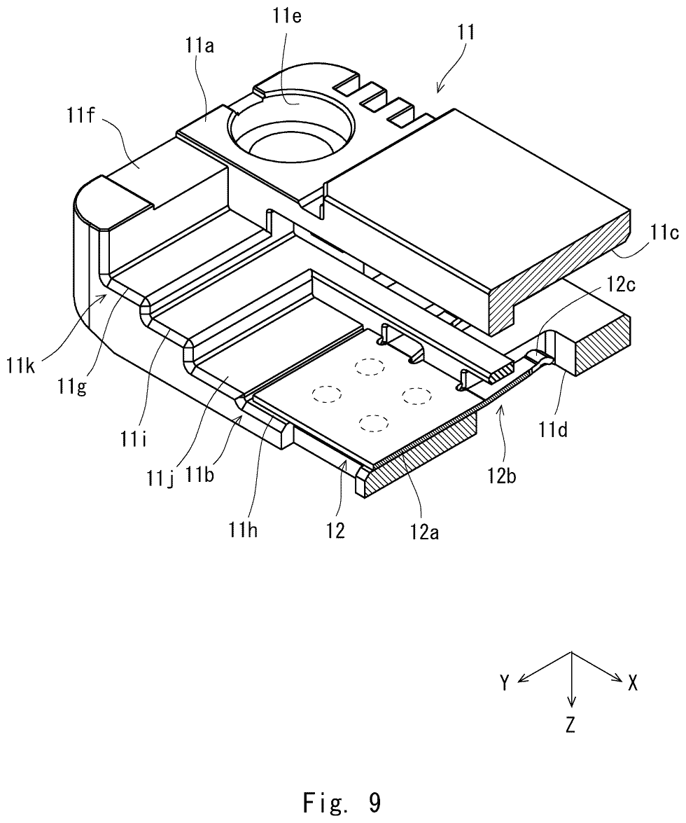

The ground plate 12, which is made of, for example, a conductive metal, is electrically connected to the ground of the connection connector 4. FIG. 9 is a YZ cross-sectional view showing a state in which the ground plate of the interface connector according to this embodiment is fixed to the housing.

As shown in FIGS. 6 and 9, for example, the ground plate 12 includes a flat part 12a and elastic deformation parts 12b. The flat part 12a is, for example, a flat body having a substantially rectangular shape as seen from the Z-axis direction, and the width of the flat part 12a is slightly smaller than the width of the second flat part 11h of the cutout 11b of the housing 11.

As shown in FIGS. 6 and 9, for example, the elastic deformation parts 12b, which are flat bodies each having a substantially rectangular shape that is long in the Y-axis direction as seen from the Z-axis direction, each include an electric contact 12c that is curved to have a convex shape on the negative side of the Z-axis at an end part on the negative side of the Y-axis of the elastic deformation part 12b. The elastic deformation parts 12b are protruded toward the negative side of the Y-axis from the flat part 12a. In this state, the elastic deformation parts 12b may be inclined in the negative direction of the Z-axis toward the negative side of the Y-axis.

As shown in FIG. 9, the flat part 12a is joined to the second flat part 11h of the cutout 11b of the housing 11 by means such as laser welding in a state in which the elastic deformation parts 12b are made to pass through the second penetrating holes 11d of the housing 11 from the positive side of the Y-axis, whereby the above-described ground plate 12 may be fixed to the housing 11.

In the above state, the electric contacts 12c of the ground plate 12 are protruded from the periphery of the first penetrating hole 11c of the housing 11 toward the inside of the first penetrating hole 11c. Note that FIG. 9 shows the welded parts of the ground plate 12 by broken lines.

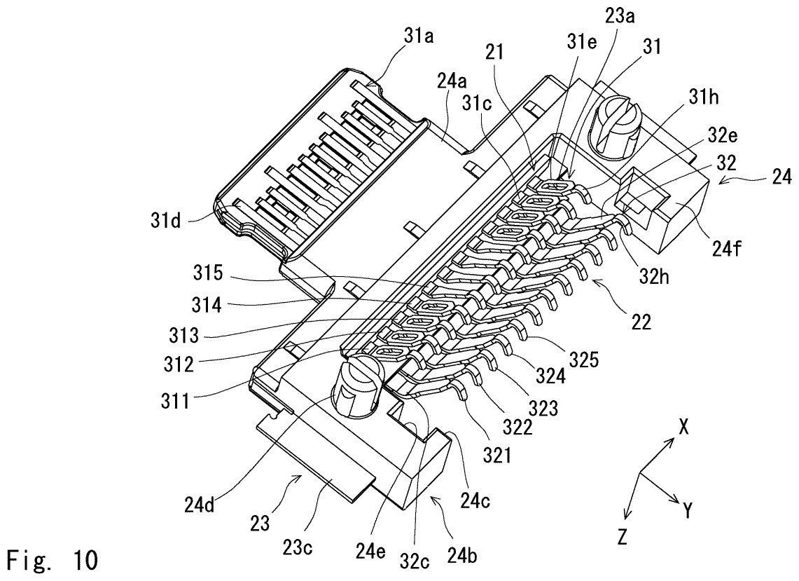

As shown in FIGS. 3 to 6, for example, the contact assembly 13 includes a first contact group 21, a second contact group 22, a midplate 23, an insulating member 24, and a locator 25. FIG. 10 is a perspective view showing a state in which the first contact group, the second contact group, the midplate, and the insulating member of the interface connector according to this embodiment are integrated as seen from the negative side of the Z-axis.

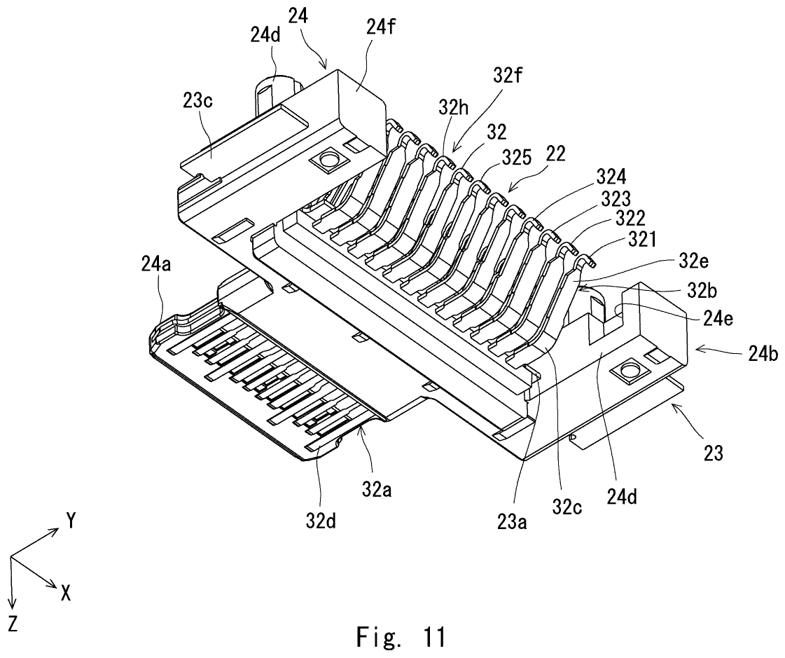

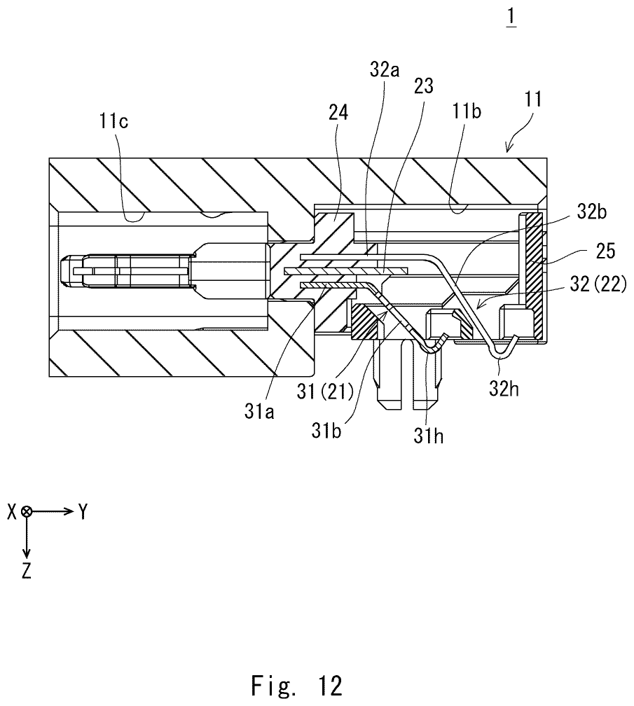

FIG. 11 is a perspective view showing the state in which the first contact group, the second contact group, the midplate, and the insulating member of the interface connector according to this embodiment are integrated as seen from the positive side of the Z-axis. FIG. 12 is a YZ cross-sectional view showing the interface connector according to this embodiment.

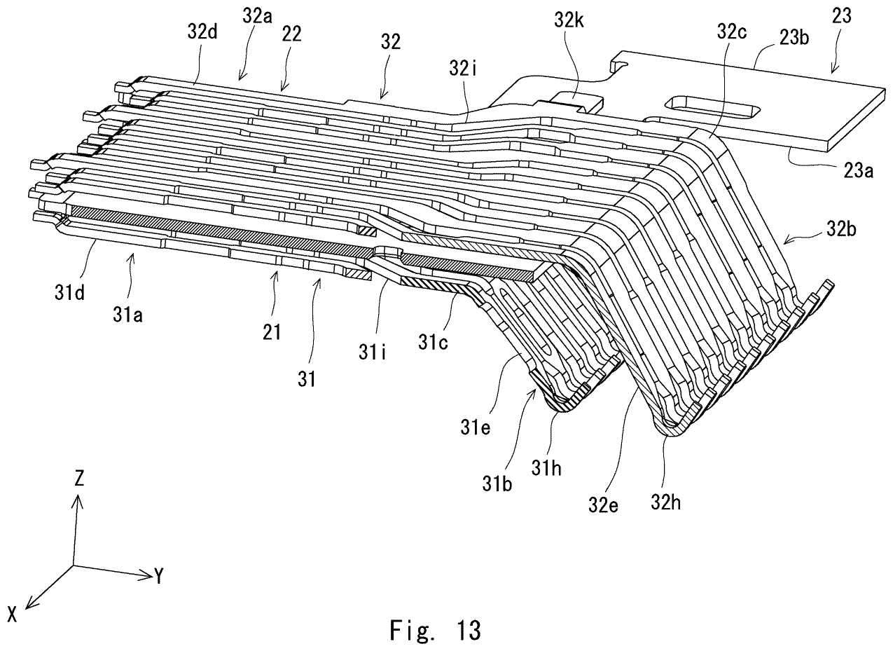

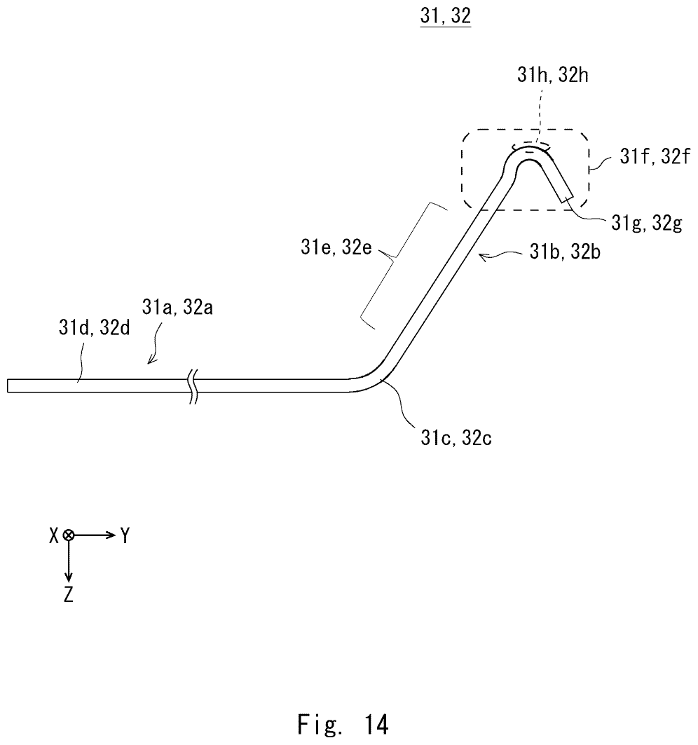

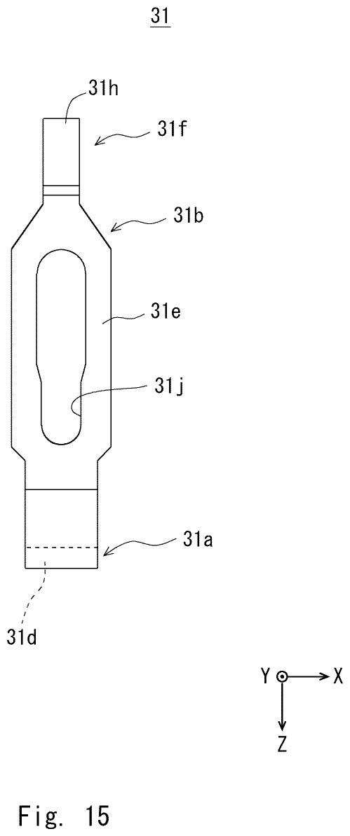

FIG. 13 is a YZ cross-sectional view showing the first contact group, the second contact group, and the midplate of the interface connector according to this embodiment. FIG. 14 is a diagram showing a contact from the negative side of the X-axis in order to describe the name of each part of the contact of the interface connector according to this embodiment. FIG. 15 is a diagram showing a representative contact of the interface connector according to this embodiment as seen from the positive side of the Y-axis.

The first contact group 21 is formed of conductive members, and includes a plurality of contacts 31, as shown in FIGS. 10 to 13. As shown in FIGS. 14 and 15, for example, the contact 31, which is a compression contact having a substantially L shape as seen from the X-axis direction, includes a first part 31a, a second part 31b, and an elastic deformation part 31c.

As shown in FIGS. 12 to 15, the first part 31a, which is disposed in substantially parallel to the XY-plane, is extended in the Y-axis direction. The part on the negative side of the Y-axis of the first part 31a forms a first electric contact 31d electrically connected to the contact of the connection connector 4.

As shown in FIGS. 12 to 15, the second part 31b, which includes a middle part 31e and a front end part 31f, is extended in the Y-axis direction. The middle part 31e is inclined in the negative direction of the Z-axis toward the positive side of the Y-axis.

As shown in FIG. 14, the front end part 31f is curved to have a convex shape on the negative side of the Z-axis as seen from the X-axis direction, and the end part on the negative side of the Y-axis of the front end part 31f is connected to the end part on the negative side of the Z-axis of the middle part 31e. Then, the end part on the positive side of the Y-axis of the front end part 31f forms an opening end 31g.

As shown in FIGS. 14 and 15, the end part on the negative side of the Z-axis of the front end part 31f (that is, the top part) forms a second electric contact 31h electrically connected to a signal terminal 2b of the connection substrate 2. The elastic deformation part 31c connects the end part on the positive side of the Y-axis of the first part 31a to the end part on the negative side of the Y-axis of the second part 31b.

As shown in FIG. 13, the above-described contacts 31 are disposed so as to be spaced apart from each other in the X-axis direction in such a way that the positions of the first electric contacts 31d of the contacts 31 correspond to the positions where contacts of the connection connector 4 are disposed and the positions of the second electric contacts 31h of the contacts correspond to the positions where the signal terminals 2b of the connection substrate 2 are disposed.

In the above state, as shown in FIG. 13, for example, the first parts 31a of the contacts 31 may each include, for example, a curved part 31i that is curved outward of the interface connector 1 in the X-axis direction toward the positive side of the Y-axis in accordance with the arrangement of the second electric contacts 31h of the contacts 31.

As shown in FIG. 10, for example, contacts 31 that are disposed on both sides of the first contact group 21 in the X-axis direction may each form a ground contact 311, and contacts 31 that are adjacent to the respective ground contacts 311 on the inner side of the interface connector 1 in the X-axis direction may form first high-speed signal contacts 312.

As shown in FIG. 10, for example, contacts 31 that are adjacent to the respective first high-speed signal contact 312 on the inner side of the interface connector 1 in the X-axis direction may each form a second high-speed signal contact 313.

As shown in FIG. 10, for example, contacts 31 that are adjacent to the respective second high-speed signal contacts 313 on the inner side of the interface connector 1 in the X-axis direction may each form a power supply contact 314, and the other contacts 31 may form low-speed signal contacts 315.

Then, as shown in FIG. 15, the width dimension of the middle part 31e of the ground contact 311, the middle part 31e of the first high-speed signal contact 312, the middle part 31e of the second high-speed signal contact 313, and the middle part 31e of the power supply contact 314 in the X-axis direction may be greater than the width dimension of the front end part 31f of each of the contacts 311, 312, 313, and 314 in the X-axis direction.

Accordingly, the gap between the ground contact 311 and the first high-speed signal contact 312, the gap between the first high-speed signal contact 312 and the second high-speed signal contact 313, and the gap between the second high-speed signal contact 313 and the power supply contact 314 in the X-axis direction can be narrowed, whereby it is possible to reduce impedance of each of the contacts 311, 312, 313, and 314.

While specific functions will be described later, as shown in FIG. 15, the middle part 31e of the ground contact 311, the middle part 31e of the first high-speed signal contact 312, the middle part 31e of the second high-speed signal contact 313, and the middle part 31e of the power supply contact 314 may each include a penetrating hole 31j. The penetrating hole 31j is extended along the middle part 31e of each of the contacts 311, 312, 313, and 314.

As shown in FIGS. 10 to 13, the second contact group 22 includes a plurality of contacts 32 having substantially the same shape as that of the contacts 31 of the first contact group 21. Therefore, although the detailed descriptions will be omitted, as shown in FIG. 14, the contact 32 includes a first part 32a, a second part 32b including a middle part 32e and a front end part 32f, and an elastic deformation part 32c.

In the above state, the length of the first part 32a of the contact 32 in the Y-axis direction is greater than the length of the first part 31a of the contact 31 of the first contact group 21 in the Y-axis direction. Further, the length of the middle part 32e of the second part 32b of the contact 32 in the lengthwise direction is greater than the length of the middle part 31e of the second part 31b of the contact 31 of the first contact group 21 in the lengthwise direction.

As shown in FIG. 14, a part on the negative side of the Y-axis of the first part 32a of the contact 32 forms a first electric contact 32d electrically connected to the contact of the connection connector 4. Further, the end part on the negative side of the Z-axis of the front end part 32f in the second part 32b of the contact 32 forms a second electric contact 32h electrically connected to the signal terminal 2b of the connection substrate 2.

As shown in FIG. 13, the above contacts 32 are also disposed so as to be spaced apart from each other in the X-axis direction in such a way that the positions of the first electric contacts 32d of the contacts 32 correspond to the positions where contacts of the connection connector 4 are disposed and the positions of the second electric contacts 32h of the contacts 32 correspond to the positions where the signal terminals 2b of the connection substrate 2 are disposed.

In the above state, as shown in FIG. 13, the first electric contacts 32d of the contacts 32 are disposed on the positive side of the Z-axis relative to the first electric contacts 31d of the contacts 31 of the first contact group 21. Further, the second electric contacts 32h of the contacts 32 are disposed on the positive side of the Y-axis relative to the second electric contacts 31h of the contacts 31 of the first contact group 21.

That is, as shown in FIG. 13, the second contact group 22 is disposed so as to cover the first contact group 21 from the positive side of the Z-axis and the positive side of the Y-axis. Then, the end part on the negative side of the Z-axis of each of the second electric contacts 32h of the contacts 32 is disposed at a height substantially equal to that of the end part on the negative side of the Z-axis of each of the second electric contacts 31h of the contacts 31 of the first contact group 21 in the Z-axis direction.

As shown in FIG. 13, for example, the first parts 32a of the contacts 32 may also each include a curved part 32i that is curved outward of the interface connector 1 in the X-axis direction toward the positive side of the Y-axis in accordance with the arrangement of the second electric contacts 32h of the contacts 32.

As shown in FIGS. 10 and 11, for example, contacts 32 that are disposed on both sides of the second contact group 22 in the X-axis direction may each form a ground contact 321, and contacts 32 that are adjacent to the respective ground contacts 321 on the inner side of the interface connector 1 in the X-axis direction may form first high-speed signal contacts 322.

As shown in FIGS. 10 and 11, for example, contacts 32 that are adjacent to the respective first high-speed signal contacts 322 on the inner side of the interface connector 1 in the X-axis direction may each form a second high-speed signal contact 323.

For example, as shown in FIGS. 10 and 11, contacts 32 that are adjacent to the respective second high-speed signal contacts 323 on the inner side of the interface connector 1 in the X-axis direction may each form a power supply contact 324, and the other contacts 32 may form low-speed signal contacts 325.

Then, as shown in FIG. 11, the width dimension of the middle part 32e of the ground contact 321, the middle part 32e of the first high-speed signal contact 322, the middle part 32e of the second high-speed signal contact 323, and the middle part 32e of the power supply contact 324 in the X-axis direction may be greater than the width dimension of the front end part 32f of each of the contacts 321, 322, 323, and 324 in the X-axis direction.

Note that the middle part 32e of each of the contacts 321, 322, 323, and 324 of the second contact group 22 may include a penetrating hole, like in the middle part 31e of each of the contacts 311, 312, 313, and 314 of the first contact group 21, or may not include the penetrating hole.

Accordingly, the gap between the ground contact 321 and the first high-speed signal contact 322, the gap between the first high-speed signal contact 322 and the second high-speed signal contact 323, and the gap between the second high-speed signal contact 323 and the power supply contact 324 in the X-axis direction can be narrowed, whereby it is possible to reduce impedance of each of the contacts 321, 322, 323, and 324.

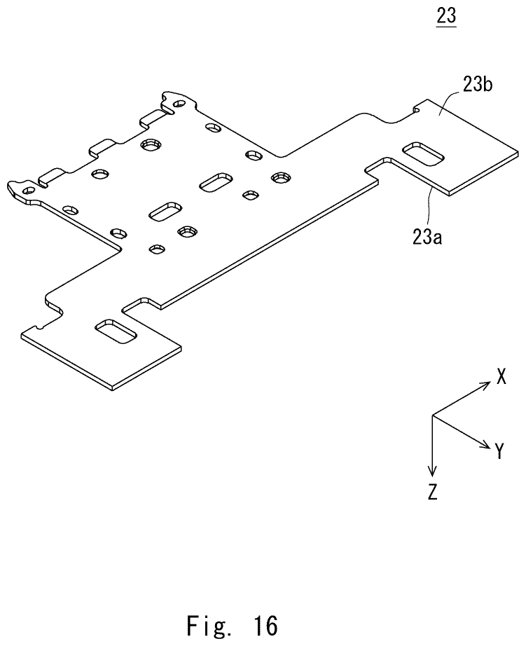

FIG. 16 is a perspective view of the midplate of the interface connector according to this embodiment as seen from the negative side of the Z-axis. The midplate 23 is a conductive metal plate. As shown in FIG. 16, for example, the midplate 23, which is a plate body that is substantially parallel to the XY-plane, has a substantially T shape as seen from the Z-axis direction.

As shown in FIG. 16, the midplate 23 includes a cutout 23a that reaches the end part on the positive side of the Y-axis of the midplate 23. The cutout 23a, which is disposed at substantially the center of the midplate 23 in the X-axis direction, has a substantially rectangular shape as seen from the Z-axis direction. Therefore, a part on the positive side of the Y-axis of the midplate 23 has a substantially C shape as seen from the Z-axis direction.

As shown in FIGS. 12 and 13, the midplate 23 is disposed between the first parts 31a of the contacts 31 of the first contact group 21 and the first parts 32a of the contacts 32 of the second contact group 22 in the Z-axis direction. Accordingly, it is possible to control crosstalk between the contacts 31 of the first contact group 21 and the contacts 32 of the second contact group 22.

In the above state, the second parts 32b of the contacts 32 of the second contact group 22 are disposed in the cutout 23a of the midplate 23 as seen from the Z-axis direction. Further, the flat parts 23b provided on both sides of the midplate 23 in the X-axis direction with the cutout 23a interposed therebetween are disposed outward of the interface connector 1 in the X-axis direction with respect to the first contact group 21 and the second contact group 22 as seen from the Z-axis direction.

As shown in FIG. 13, for example, a connection part (not shown) formed in the ground contact 311 of the first contact group 21 and a connection part 32k formed in the ground contact 321 of the second contact group 22 may be electrically connected in the flat part 23b of the midplate 23.

The insulating member 24 is made of, for example, an insulating resin, and holds, as shown in FIGS. 10 and 11, the first contact group 21, the second contact group 22, and the midplate 23. The insulating member 24, which has, for example, a substantially T shape as seen from the Z-axis direction, includes a first part 24a and a second part 24b.

As shown in FIGS. 10 and 11, for example, the first part 24a, which has a substantially rectangular shape that is long in the X-axis direction as seen from the Y-axis direction, is extended in the Y-axis direction. A part on the negative side of the Y-axis of the first part 24a is formed in a shape that it can be fit with the connection connector 4.

As shown in FIGS. 10 and 11, the second part 24b is connected to the end part on the positive side of the Y-axis of the first part 24a. In this state, the first part 24a is disposed, for example, at substantially the center of the second part 24b in the X-axis direction.

As shown in FIGS. 10 and 11, for example, the second part 24b, which has a substantially rectangular shape that is long in the X-axis direction as seen from the Y-axis direction, is extended in the Y-axis direction. The second part 24b includes, for example, a first cutout 24c, positioning pins 24d, and second cutouts 24e.

As shown in FIGS. 10 and 11, the first cutout 24c reaches the end part on the positive side of the Y-axis of the second part 24b. The first cutout 24c, which is disposed at substantially the center of the second part 24b in the X-axis direction, has a substantially rectangular shape as seen from the Z-axis direction. Therefore, the second part 24b has a substantially C shape as seen from the Z-axis direction.

When the interface connector 1 is fixed to the connection substrate 2, the positioning pins 24d are inserted into positioning holes 2c (see FIG. 2) of the connection substrate 2. As shown in FIG. 10, for example, the positioning pins 24d are protruded toward the negative side of the Z-axis from parts 24f on both respective sides of the second part 24b in the X-axis direction with the first cutout 24c interposed therebetween. The positioning pins 24d may each have, for example, a substantially circular shape as seen from the Z-axis direction.

As shown in FIGS. 10 and 11, for example, the second cutouts 24e are formed in the parts 24f on the both respective sides of the second part 24b in the X-axis direction with the first cutout 24c interposed therebetween. The second cutouts 24e cut out, for example, corner parts on the inner side of the interface connector 1 on the negative side of the Z-axis of the parts 24f on the both respective sides of the second part 24b in the X-axis direction with the first cutout 24c interposed therebetween.

As shown in FIGS. 10 and 11, for example, the second cutouts 24e, each of which have a substantially rectangular shape as seen from the Z-axis direction, are extended in the Z-axis direction. The second cutouts 24e are disposed, for example, in such a way that they face each other in the X-axis direction.

The aforementioned insulating member 24 holds the first contact group 21, the second contact group 22, and the midplate 23 in a state in which the first contact group 21, the second contact group 22, and the midplate 23 are embedded inside the insulating member 24.

In the above state, as shown in FIG. 10, the first electric contacts 31d of the contacts 31 of the first contact group 21 are exposed from the surface on the negative side of the Z-axis of the first part 24a. Further, as shown in FIG. 11, the first electric contacts 32d of the contacts 32 of the second contact group 22 are exposed from the surface on the positive side of the Z-axis of the first part 24a.

Then, as shown in FIGS. 10 and 11, the part on the positive side of the Y-axis including the elastic deformation parts 31c of the contacts 31 of the first contact group 21, and the part on the positive side of the Y-axis including the part on the positive side of the Y-axis of the first part 32a of the contacts 32 of the second contact group 22 are disposed in the first cutout 24c of the second part 24b as seen from the Z-axis direction.

Therefore, as shown in FIG. 12, the length of the contact 32 of the second contact group 22 that is exposed from the insulating member 24 toward the positive side of the Y-axis is greater than the length of the contact 31 of the first contact group 21 that is exposed from the insulating member 24 toward the positive side of the Y-axis.

Further, as shown in FIGS. 10 and 11, the end part on the positive side of the X-axis of the flat part 23b on the positive side of the X-axis of the midplate 23 is protruded from the side surface on the positive side of the X-axis of the part 24f on the positive side of the X-axis with respect to the first cutout 24c in the second part 24b.

Further, as shown in FIGS. 10 and 11, the end part on the negative side of the X-axis of the flat part 23b on the negative side of the X-axis of the midplate 23 is protruded from the side surface on the negative side of the X-axis of the part 24f on the negative side of the X-axis with respect to the first cutout 24c in the second part 24b. That is, the midplate 23 includes a protruding part 23c that is protruded from the insulating member 24 in the X-axis direction.

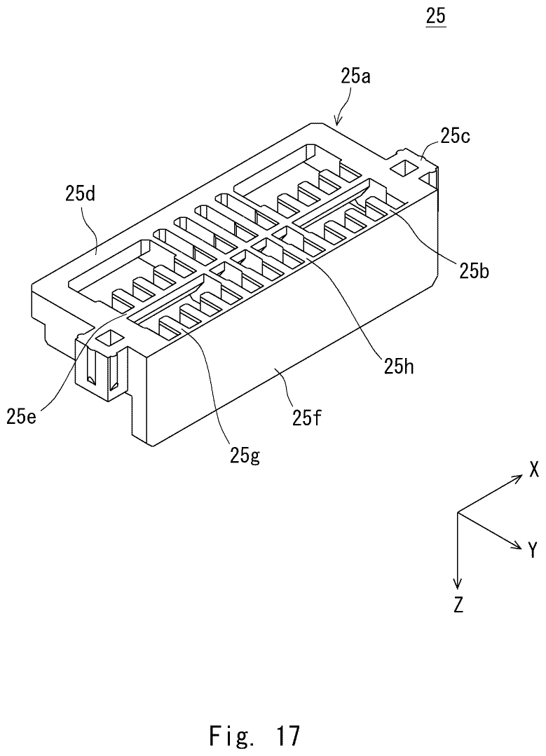

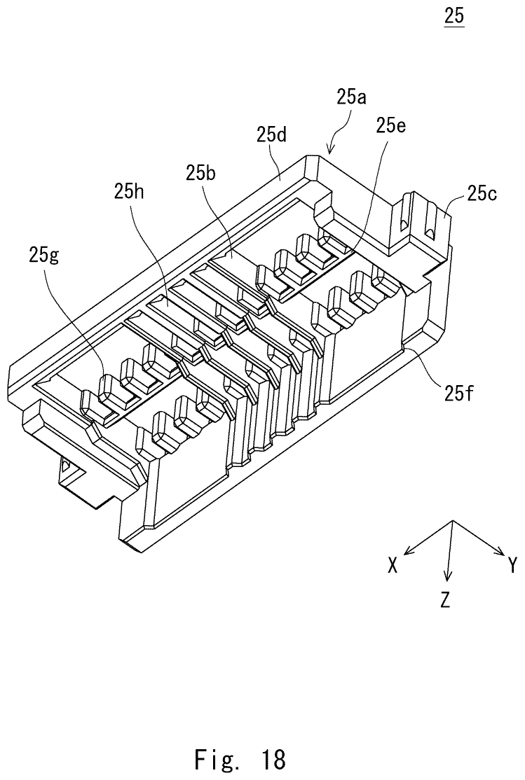

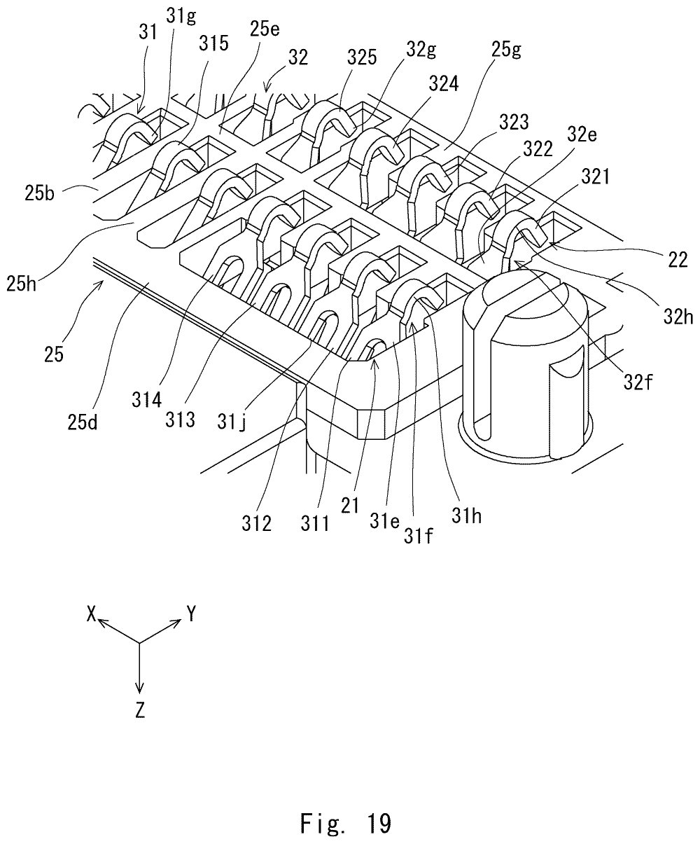

FIG. 17 is a perspective view of the locator of the interface connector according to this embodiment as seen from the negative side of the Z-axis. FIG. 18 is a perspective view of the locator of the interface connector according to this embodiment as seen from the positive side of the Z-axis. FIG. 19 is an enlarged view of a part XIX of FIG. 4.

The locator 25 controls a positional displacement of the front end parts 31f of the contacts 31 of the first contact group 21 and the front end parts 32f of the contacts 32 of the second contact group 22 in the X-axis direction. The locator 25 may be made of, for example, an insulating resin, and includes a frame 25a, partition walls 25b, and convex parts 25c, as shown in FIGS. 17 and 18.

As shown in FIGS. 17 and 18, for example, the frame 25a includes a main body 25d and a beam 25e. The main body 25d is, for example, an annular body that has a substantially rectangular shape that is long in the X-axis direction as seen from the Z-axis direction. The outer shape of the main body 25d is substantially equal to the inner shape of the first cutout 24c of the insulating member 24 as seen from the Z-axis direction.

Further, the inner shape of the main body 25d is formed so as to be able to accommodate the part of the contacts 31 of the first contact group 21 exposed from the insulating member 24 toward the positive side of the Y-axis and the part of the contacts 32 of the second contact group 22 exposed from the insulating member 24 toward the positive side of the Y-axis as seen from the Z-axis direction.

In the above state, as shown in FIGS. 17 and 18, for example, the main body 25d may include a wall 25f hanging down from a part on the positive side of the Y-axis of the main body 25d toward the positive side of the Z-axis. The wall 25f may be, for example, a flat body having a substantially rectangular shape that is long in the X-axis direction as seen from the Y-axis direction. Then, the height of the main body 25d including the wall 25f in the Z-axis direction may be greater than the thickness of the second part 24b of the insulating member 24 in the Z-axis direction.

As shown in FIGS. 17 and 18, the beam 25e, which is disposed at substantially the center of the main body 25d in the Y-axis direction, is extended in the X-axis direction so as to bridge between the part on the positive side of the X-axis of the main body 25d and the part on the negative side of the X-axis of the main body 25d. The beam 25e, which has a substantially rectangular shape that is long in the X-axis direction as seen from the Y-axis direction, is disposed in a part on the negative side of the Z-axis of the main body 25d.

The partition walls 25b are disposed between the contacts 31 of the first contact group 21 and between the contacts 32 of the second contact group 22. Here, as shown in FIGS. 17 and 18, for example, the partition walls 25b include first partition walls 25g and second partition walls 25h.

As shown in FIG. 19, for example, the first partition walls 25g are protruded from the beam 25e of the frame 25a toward the negative side of the Y-axis so as to correspond to the arrangement of the ground contacts 311, the first high-speed signal contacts 312, the second high-speed signal contacts 313, and the power supply contacts 314 of the first contact group 21.

Therefore, as shown in FIGS. 17 and 18, for example, three first partition walls 25g may be disposed in each of the part on the positive side of the X-axis of the beam 25e of the frame 25a and the part on the negative side of the X-axis of the beam 25e of the frame 25a. In this state, the first partition walls 25g do not reach a part on the negative side of the Y-axis of the main body 25d of the frame 25a.

Further, as shown in FIG. 19, for example, the first partition walls 25g are protruded toward the negative side of the Y-axis from a part on the positive side of the Y-axis of the main body 25d of the frame 25a so as to correspond to the arrangement of the ground contacts 321, the first high-speed signal contacts 322, the second high-speed signal contacts 323, and the power supply contacts 324 of the second contact group 22.

Therefore, as shown in FIGS. 17 and 18, for example, three first partition walls 25g may be disposed in each of the part on the positive side of the X-axis and the part on the negative side of the X-axis of the part on the positive side of the Y-axis of the main body 25d of the frame 25a. In this state, the first partition walls 25g do not reach the beam 25e of the frame 25a.

As shown in FIGS. 17 and 18, for example, the first partition walls 25g may each be a flat body having a substantially rectangular shape as seen from the X-axis direction. Then, the first partition walls 25g may be disposed in a part on the negative side of the Z-axis of the frame 25a.

Here, the gap between the first partition walls 25g that are adjacent to each other in the X-axis direction may be greater than the width dimension of the front end parts 31f and 32f of the respective contacts 31 and 32 in the X-axis direction but narrower than the width dimension of the middle parts 31e and 32e of the respective contacts 31 and 32 in the X-axis direction.

As shown in FIG. 19, for example, the second partition walls 25h are protruded from the beam 25e of the frame 25a toward the negative side of the Y-axis so as to correspond to the arrangement of the low-speed signal contacts 315 of the first contact group 21.

Therefore, as shown in FIGS. 17 and 18, for example, the second partition walls 25h are disposed between the three first partition walls 25g on the positive side of the X-axis and the three first partition walls 25g on the negative side of the X-axis in the beam 25e of the frame 25a in the X-axis direction. In this state, the second partition walls 25h are disposed so as to bridge between the beam 25e of the frame 25a and the part on the negative side of the Y-axis of the main body 25d of the frame 25a.

Further, as shown in FIG. 19, for example, the second partition walls 25h are protruded toward the negative side of the Y-axis of the main body 25d of the frame 25a from the part on the positive side of the Y-axis thereof so as to correspond to the arrangement of the low-speed signal contacts 325 of the second contact group 22.

Therefore, as shown in FIGS. 17 and 18, for example, the second partition walls 25h are disposed between the three first partition walls 25g on the positive side of the X-axis and the three first partition walls 25g on the negative side of the X-axis of a part on the positive side of the Y-axis of the main body 25d of the frame 25a in the X-axis direction.

In the above state, as shown in FIGS. 17 and 18, the second partition walls 25h are disposed so as to bridge between the part on the positive side of the Y-axis of the main body 25d of the frame 25a and the beam 25e. The second partition walls 25h may each be, for example, a flat body having a substantially rectangular shape as seen from the X-axis direction. Then the second partition walls 25h may be disposed in a part on the negative side of the Z-axis of the frame 25a.

As shown in FIGS. 17 and 18, the convex parts 25c are protruded on the outward of the interface connector 1 from a part on the positive side of the X-axis and a part on the negative side of the X-axis of the main body 25d of the frame 25a in the X-axis direction.

As shown in FIG. 3, the convex parts 25c are designed in such a way that they can mate with the second cutouts 24e of the insulating member 24. Therefore, the convex parts 25c, each of which have, for example, a substantially rectangular shape as seen from the Z-axis direction, are extended in the Z-axis direction.

The convex parts 25c of the locator 25 are fit into the second cutouts 24e of the insulating member 24 while the locator 25 is inserted into the first cutout 24c of the insulating member 24, whereby the aforementioned locator 25 is fixed to the insulating member 24.

In the above state, as shown in FIG. 19, the first partition walls 25g are disposed between the opening ends 31g and 32g of the front end parts 31f and 32f of the ground contacts 311 and 321 and the opening ends 31g and 32g of the front end parts 31f and 32f of the first high-speed signal contacts 312 and 322.

In addition, as shown in FIG. 19, the first partition walls 25g are disposed between the opening ends 31g and 32g of the front end parts 31f and 32f of the first high-speed signal contacts 312 and 322 and the opening ends 31g and 32g of the front end parts 31f and 32f of the second high-speed signal contacts 313 and 323.

Further, as shown in FIG. 19, the first partition walls 25g are disposed between the opening ends 31g and 32g of the front end parts 31f and 32f of the second high-speed signal contacts 313 and 323 and the opening ends 31g and 32g of the front end parts 31f and 32f of the power supply contacts 314 and 324.

On the other hand, as shown in FIG. 19, the first partition walls 25g are not disposed between the middle parts 31e and 32e of the ground contacts 311 and 321 and the middle parts 31e and 32e of the first high-speed signal contacts 312 and 322.

In addition, as shown in FIG. 19, the first partition walls 25g are not disposed between the middle parts 31e and 32e of the first high-speed signal contacts 312 and 322 and the middle parts 31e and 32e of the second high-speed signal contacts 313 and 323, and between the middle parts 31e and 32e of the second high-speed signal contacts 313 and 323 and the middle parts 31e and 32e of the power supply contacts 314 and 324.

As shown in FIG. 19, the second partition walls 25h are disposed between the opening ends 31g and 32g of the front end parts 31f and 32f of the power supply contacts 314 and 324 and the opening ends 31g and 32g of the front end parts 31f and 32f of the low-speed signal contacts 315 and 325, and between the opening ends 31g and 32g of the front end parts 31f and 32f of low-speed signal contacts 315 and 325 and those of low-speed signal contacts 315 and 325 adjacent thereto.

In addition, as shown in FIG. 19, the second partition walls 25h are also disposed between the middle parts 31e and 32e of the power supply contacts 314 and 324 and the middle parts 31e and 32e of the low-speed signal contacts 315 and 325, and between the middle parts 31e and 32e of low-speed signal contacts 315 and 325 and those of low-speed signal contacts 315 and 325 adjacent thereto.

Then, as shown in FIG. 4, the second electric contacts 31h of the first contact group 21 and the second electric contacts 32h of the second contact group 22 are protruded toward the negative side of the Z-axis from the surface on the negative side of the Z-axis of the locator 25. Further, the wall 25f of the main body 25d of the frame 25a blocks an opened part on the positive side of the Y-axis of the first cutout 24c of the insulating member 24.

Note that the second partition walls 25h of the locator 25 may cut out a part that interferes with the middle parts 31e and 32e of the contacts 31 and 32. Further, the frame 25a of the locator 25 may cut out a part that interferes with the insulating member 24 when the locator 25 is fixed to the insulating member 24.

With the configuration of the locator 25 described above, it is possible to control the positional displacement in the X-axis direction between the front end parts 31f including the second electric contacts 31h of the respective contacts 31 of the first contact group 21 and the front end parts 32f including the second electric contacts 32h of the respective contacts 32 of the second contract group 22.

In addition, the first partition walls 25g are not disposed between the middle parts 31e and 32e of some of the contacts 31 and 32. Therefore, it is possible to increase the width dimension of the middle parts 31e and 32e of at least some of the contacts 31 and 32 in the X-axis direction and narrow the gaps between some of the contacts 31 and 32 in the X-axis direction, to thereby decrease the impedance of some of the contacts 31 and 32.

In particular, it is possible to increase the width dimension of the middle parts of high-speed signal contacts adjacent to each other and the middle parts of contacts adjacent to the high-speed signal contacts in the X-axis direction and thus narrow the gaps in the X-axis direction between the contacts adjacent to each other, to thereby achieve higher transmission.

Further, since the first partition walls 25g are not disposed between the middle parts 31e and 32e of some of the contacts 31 and 32, the locator 25 can be easily manufactured. Therefore, the interface connector 1 according to this embodiment is able to reduce the impedance of at least some of the contacts 31 and 32 while controlling the positional displacement of the front end parts 31f and 32f including the second electric contacts 31h and 32h of the contacts 31 and 32.

As shown in FIGS. 3 to 5, the contact assembly 13 in which the first contact group 21, the second contact group 22, the midplate 23, the insulating member 24, and the locator 25 are integrated is accommodated in the cutout 11b of the housing 11.

In the above state, for example, the protruding part 23c of the midplate 23 is joined to the first flat part 11g of the cutout 11b of the housing 11 by means such as laser welding in a state in which the protruding part 23c of the midplate 23 is placed on the first flat part 11g of the cutout 11b of the housing 11, whereby the contact assembly 13 is fixed to the housing 11. FIG. 5 shows the welded parts of the midplate 23 by broken lines.

Further, as shown in FIG. 4, the first parts 31a of the contacts 31 of the first contact group 21, the first parts 32a of the contacts 32 of the second contact group 22, and the first part 24a of the insulating member 24 are made to pass through the first penetrating hole 11c of the housing 11 toward the negative side of the Y-axis.

Then, as shown in FIG. 3, the second part 24b of the insulating member 24 is accommodated in a recessed part of the housing 11 in which the third flat part 11i of the cutout 11b is formed, and the wall 25f of the main body 25d of the frame 25a of the locator 25 is accommodated in the recessed part of the housing 11 where the second flat part 11h and the fourth flat part 11j of the cutout 11b are formed.

When the protruding part 23c of the midplate 23 of the contact assembly 13 is fixed to the first flat part 11g of the cutout 11b of the housing 11 as described above, a part around the protruding part 23c of the midplate 23 functions as an elastic deformation part, which enables the contact assembly 13 to be rotated about the X-axis.

Therefore, even when a load about the X-axis is externally applied to the connection connector 4 in a state in which the connection connector 4 is electrically connected to the interface connector 1, a part around the protruding part 23c of the midplate 23 is deformed, which causes the load to be released, whereby it is possible to prevent or reduce the contact assembly 13 from being damaged.

As shown in FIG. 8, the first penetrating hole 11c of the housing 11 may include a mated part 110 into which a part on the negative side of the Y-axis of the first part 24a of the insulating member 24 is fit. The mated part 110 is disposed in a part on the positive side of the Y-axis of the first penetrating hole 11c.

As shown in FIG. 8, for example, the mated part 110, which may have a substantially rectangular shape that is long in the X-axis direction as seen from the Y-axis direction, is recessed toward the negative side of the Y-axis from a part on the negative side of the Z-axis of the side surface 111 on the negative side of the Y-axis of the cutout 11b of the housing 11.

Next, a flow of manufacturing the interface connector 1 according to this embodiment will be described. First, the housing 11 is formed by metal injection molding (MIM) or machining (i.e., cutting). Accordingly, it is possible to form the housing 11, which has a higher rigidity than a housing formed by sheet metal. In addition, when the housing 11 is formed by metal injection molding, the housing 11 including a plurality of parts having different thicknesses in the Z-axis direction such as the cutouts 11b can be easily formed.

Next, the first contact group 21, the second contact group 22, and the midplate 23 are insert-molded into the insulating member 24 and integrated with one another. At this time, they may be insert-molded into the insulating member 24 in the state in which the contacts 31 of the first contact group 21 and the contacts 32 of the second contact group 22 are held at predetermined positions by holding members.

Then, the convex parts 25c of the locator 25 are caused to be fit into the second cutouts 24e of the insulating member 24 while the locator 25 is inserted into the first cutout 24c of the insulating member 24, whereby the contact assembly 13 is formed.

Next, the flat part 12a of the ground plate 12 is placed on the second flat part 11h of the cutout 11b of the housing 11 while the elastic deformation parts 12b of the ground plate 12 are caused to pass through the second penetrating holes 11d of the housing 11 from the positive side of the Y-axis, and the flat part 12a of the ground plate 12 and the second flat part 11h of the cutout 11b of the housing 11 are joined together by means such as laser welding.

Next, a part on the positive side of the Y-axis of the contact assembly 13 is accommodated in the cutout 11b of the housing 11 from the negative side of the Z-axis while the first parts 31a of the contacts 31 of the first contact group 21, the first parts 32a of the contacts 32 of the second contact group 22, and the first part 24a of the insulating member 24 are made to pass through the first penetrating hole 11c of the housing 11 toward the negative side of the Y-axis.

Then, the protruding part 23c of the midplate 23 and the first flat part 11g of the cutout 11b of the housing 11 are joined together by means such as laser welding in a state in which the protruding part 23c of the midplate 23 is placed on the first flat part 11g of the cutout 11b of the housing 11. It is therefore possible to manufacture the interface connector 1.

In the above state, as shown in FIG. 12, the center of the flat part 23b of the midplate 23 in the Z-axis direction and the center of the first penetrating hole 11c of the housing 11 in the Z-axis direction are disposed at a height that is substantially equal to each other in the Z-axis direction.

As described above, the protruding part 23c of the midplate 23 and the first flat part 11g of the cutout 11b of the housing 11 are welded together in the state in which the protruding part 23c of the midplate 23 is placed on the first flat part 11g of the cutout 11b of the housing 11, whereby it becomes easy to make the protruding part 23c of the midplate 23 abut to the first flat part 11g of the cutout 11b of the housing 11. Therefore, it becomes easy to weld the protruding part 23c of the midplate 23 to the first flat part 11g of the cutout 11b of the housing 11, as a result of which a ground path can be easily formed.

Next, a flow of fixing the interface connector 1 according to this embodiment to the connection substrate 2 to electrically connect the connection connector 4 to the interface connector 1 will be described. FIG. 20 is a YZ cross-sectional view showing a state in which the interface connector according to this embodiment is fixed to the connection substrate.

As shown in FIG. 2, the positioning pins 24d of the insulating member 24 of the interface connector 1 are inserted into the positioning holes 2c of the connection substrate 2 from the positive side of the Z-axis, and the housing 11 of the interface connector 1 is placed on a surface on the positive side of the Z-axis of the connection substrate 2.

In the above state, as shown in FIG. 20, the convex part 11m of the housing 11 of the interface connector 1 may be inserted into the cutout 2a of the connection substrate 2 from the positive side of the Z-axis so that the interface connector 1 can be positioned with respect to the connection substrate 2.

Next, the screws 3 are made to pass through the third penetrating holes 11e of the housing 11 of the interface connector 1 from the positive side of the Z-axis and these screws 3 are screwed into screw holes (not shown) of the connection substrate 2, whereby the interface connector 1 can be fixed to the connection substrate 2.

Accordingly, the second electric contacts 31h of the contacts 31 of the first contact group 21 and the second electric contacts 31h of the contacts 32 of the second contact group 22 of the interface connector 1 are electrically connected to the signal terminals 2b of the connection substrate 2 in a state in which the second electric contacts 31h of the contacts 31 and the second electric contacts 31h of the contacts 32 are pressed against the signal terminals 2b of the connection substrate 2 with a predetermined load.

Further, the housing 11 of the interface connector 1 is electrically connected to the ground terminal 2d of the connection substrate 2. Since the housing 11, the ground plate 12, and the midplate 23 of the interface connector 1 are made of metal, a ground path can be formed in the ground terminal 2d of the connection substrate 2 from the ground plate 12 or the midplate 23 via the housing 11.

In the above state, a part of the contact 31 of the first contact group 21 including the elastic deformation part 31c exposed on the positive side of the Y-axis from the insulating member 24 and a part of the contact 32 of the second contact group 22 including the elastic deformation part 32c exposed on the positive side of the Y-axis from the insulating member 24 are elastically deformed toward the positive side of the Z-axis.

Then, the length of the part of the contact 31 of the first contact group 21 including the elastic deformation part 31c exposed on the positive side of the Y-axis from the insulating member 24 is shorter than the length of the part of the contact 32 of the second contact group 22 including the elastic deformation part 32c exposed on the positive side of the Y-axis from the insulating member 24.

Further, the width dimension of the middle part 31e of the ground contact 311, the middle part 31e of the first high-speed signal contact 312, the middle part 31e of the second high-speed signal contact 313, and the middle part 31e of the power supply contact 314 of the first contact group 21 in the X-axis direction is greater than the width dimension of the front end part 31f of each of the contacts 311, 312, 313, and 314 in the X-axis direction.

Therefore, although each of the contacts 311, 312, 313, and 314 of the first contact group 21 is not likely to be elastically deformed toward the positive side of the Z-axis, if the middle part 31e of each of the contacts 311, 312, 313, and 314 of the first contact group 21 includes the penetrating hole 31j, a part of each of the contacts 311, 312, 313, and 314 including the elastic deformation part 31c that is exposed on the positive side of the Y-axis from the insulating member 24 can be elastically deformed toward the positive side of the Z-axis reliably.

The connection connector 4 is inserted into the above-described first penetrating hole 11c of the housing 11 of the interface connector 1 toward the positive side of the Y-axis. Accordingly, the connection connector 4 is fit into a part on the negative side of the Y-axis of the first part 24a of the insulating member 24 of the interface connector 1.

As a result, the contacts of the connection connector 4 are electrically connected to the first electric contacts 31d of the contacts 31 of the first contact group 21 of the interface connector 1 and the first electric contacts 32d of the contacts 32 of the second contact group 22 of the interface connector 1.

Further, the ground of the connection connector 4 is electrically connected to the electric contacts 12c of the ground plate 12 of the interface connector 1. Accordingly, the connection connector 4 can be electrically connected to the connection substrate 2 via the interface connector 1.

According to the interface connector 1 and the method for manufacturing the interface connector 1 according to this embodiment, the protruding part 23c of the midplate 23 of the contact assembly 13 and the first flat part 11g of the cutout 11b of the housing 11 are welded together in a state in which the protruding part 23c of the midplate 23 of the contact assembly 13 is placed on the first flat part 11g of the cutout 11b of the housing 11.

Therefore, according to the interface connector 1 and the method for manufacturing the interface connector 1 according to this embodiment, it becomes easy to make the protruding part 23c of the midplate 23 of the contact assembly 13 abut to the first flat part 11g of the cutout 11b of the housing 11.

Accordingly, it becomes easy to weld the protruding part 23c of the midplate 23 of the contact assembly 13 to the first flat part 11g of the cutout 11b of the housing 11, as a result of which a ground path can be easily formed.

Further, when the housing 11 is a molded or machined product made of metal in the interface connector 1 and the method for manufacturing the interface connector 1 according to this embodiment, the housing 11, which has a higher rigidity than a housing formed by sheet metal, can be formed. In addition, when the housing 11 is formed by metal injection molding, the housing 11 including a plurality of parts having different thicknesses in the Z-axis direction such as the cutouts 11b can be easily formed.

According to the interface connector 1 and the method for manufacturing the interface connector 1 according to this embodiment, the protruding part 23c of the midplate 23 of the contact assembly 13 is welded to the first flat part 11g of the cutout 11b of the housing 11. Therefore, a part around the protruding part 23c of the midplate 23 functions as an elastic deformation part, which enables the contact assembly 13 to be rotated about the X-axis.

Accordingly, even when a load about the X-axis is externally applied to the connection connector 4 in a state in which the connection connector 4 is electrically connected to the interface connector 1, a part around the protruding part 23c of the midplate 23 is deformed, which causes the load to be released, whereby it is possible to prevent or reduce the contact assembly 13 from being damaged.

With the configuration in which the interface connector 1 is fixed to the connection substrate 2 by the screws 3 in the interface connector 1 according to this embodiment, even if the interface connector 1 fails, the interface connector 1 can be easily replaced by another one.

The shape of the housing 11 according to the above embodiment is merely one example, and the housing 11 may have any shape as long as it includes a flat part to which the midplate 23 can be welded in the state in which the housing 11 accommodates the contact assembly 13. For example, one of the second flat part 11h, the third flat part 11i, or the fourth flat part 11j may be omitted or may be shared. That is, the cutout 11b may have any shape as long as it can cause the insulating member 24 and the locator 25 to be released when the protruding part 23c of the midplate 23 is welded to the first flat part 11g of the cutout 11b of the housing 11. Further, the housing 11 may not be a molded or machined product.

The configuration of the contact assembly 13 according to the above embodiment is merely one example, and the contact assembly 13 may have any configuration as long as it includes a metal plate that can be welded to the flat part of the housing 11.

The shape of the contacts 31 and 32 according to the above embodiment is merely an example, and they may have any shape as long as they can be electrically connected to the signal terminals 2b of the connection substrate 2 and the contacts of the connection connector 4. Further, while the interface connector 1 according to this embodiment includes the first contact group 21 and the second contact group 22, it may include a single contact group or a plurality of contact groups, and the number of groups is not particularly limited.

The shape of the insulating member 24 according to the above embodiment is merely an example, and the insulating member 24 may have any shape as long as it can hold contacts.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An interface connector for electrically connecting a connection connector to a connection substrate, the interface connector comprising:
a housing; and
a contact assembly held by the housing, wherein
the housing is a shell block including a plurality of parts having different thicknesses and has a cutout which accommodates the contact assembly,
the contact assembly comprises:
contacts including first electric contacts electrically connected to the connection connector and second electric contacts electrically connected to the connection substrate;
a metal plate; and
an insulating member that holds the contacts and the metal plate and into which the connection connector is fit, and
a protruding part of the metal plate protruded from the insulating member in a width direction of the housing is welded to a first flat part of a cutout of the housing, the first flat part being formed in an end part of the cutout of the housing in the width direction of the housing, in a state in which the protruding part of the metal plate is placed on the first flat part of the cutout of the housing.

2. The interface connector according to claim 1, wherein
the housing includes a first penetrating hole into which the connection connector is inserted to cause the connection connector to fit into the insulating member,
the first penetrating hole is continuous with the cutout, and
a part of the insulating member that holds the first electric contacts of the contacts is fit into the first penetrating hole.

3. The interface connector according to claim 2, wherein a center of the first penetrating hole in a thickness direction of the housing matches a center of the metal plate in a thickness direction.

4. The interface connector according to claim 3, comprising:
a ground plate including a flat part and an elastic deformation part protruded from the flat part, wherein
the cutout includes a second flat part disposed in an inside of the cutout with respect to the first flat part in the width direction of the housing,
the housing includes a second penetrating hole that penetrates through the housing in a thickness direction and is continuous with the first penetrating hole and the cutout,
a front end part of the elastic deformation part of the ground plate includes an electric contact,
the flat part of the ground plate is welded to the second flat part of the housing in a state in which the flat part of the ground plate is placed on the second flat part of the housing, and
the electric contact of the elastic deformation part of the ground plate is protruded from the first penetrating hole of the housing toward the inside of the first penetrating hole in a state in which the electric contact is made to pass through the second penetrating hole of the housing.

5. The interface connector according to claim 4, wherein
the cutout includes a third flat part that is disposed between the first flat part and the second flat part in the width direction of the housing, and
the insulating member is accommodated in a recessed part of the cutout where the third flat part is formed.

6. The interface connector according to claim 4, comprising:
a locator that is held in the insulating member and corrects a positional displacement of the second electric contacts in the width direction of the housing, wherein
the cutout includes a fourth flat part that is disposed between the first flat part and the second flat part in the width direction of the housing, and
the locator is accommodated in a recessed part of the cutout where the fourth flat part is formed.

7. The interface connector according to claim 1, wherein each of the contacts is a compression connector including an elastic deformation part that is elastically deformed and presses the second electric contact against a terminal provided in the connection substrate with a predetermined load in a state in which the interface connector is fixed to the connection substrate to cause the interface connector to be electrically connected to the connection substrate.

8. The interface connector according to claim 7, comprising:
a first contact group in which the contacts are disposed in such a way that they are spaced apart from each other in the width direction of the housing; and
a second contact group in which the contacts are disposed in such a way that they are spaced apart from each other in the width direction of the housing, wherein
the first electric contacts of the contacts in the second contact group are disposed on a side of the housing opposite to a side thereof where the second electric contacts of the contacts of the first contact group and the second electric contacts of the contacts of the second contact group are disposed in a thickness direction of the housing relative to the first electric contacts of the contacts of the first contact group,
the second electric contacts of the contacts of the second contact group are disposed on a side of a direction in which the connection connector is fit into the insulating member relative to the second electric contacts of the contacts of the first contact group, and
the metal plate is disposed between the first contact group and the second contact group.

9. The interface connector according to claim 1, wherein the housing includes a third penetrating hole into which a screw for fixing the interface connector to the connection substrate is inserted to cause the interface connector to be electrically connected to the connection substrate.

10. A method for manufacturing an interface connector for electrically connecting a connection connector to a connection substrate, the interface connector comprising:
a housing; and
a contact assembly held by the housing, the method comprising:
forming a shell block including a plurality of parts having different thicknesses as the housing;
insert-molding contacts including first electric contacts electrically connected to the connection connector and second electric contacts electrically connected to the connection substrate and a metal plate into an insulating member to form a contact assembly;
accommodating the contact assembly in a cutout formed in the housing; and
welding a protruding part of the metal plate protruded from the insulating member in a width direction of the housing to a flat part of a cutout of the housing, the flat part being formed in an end part of the cutout of the housing in the width direction of the housing, in a state in which the protruding part is placed on the flat part of the cutout of the housing.
